(19) United States
(12) Patent Application Publication
(10) Pub. No.: US 2002/0150710 A1
(43) Pub. Date: Oct. 17, 2002

(54) System for protecting vehicles from damage from walls and posts in garages

(76) Inventor: Michael L. Russo, Wilmington, MA (US)

Correspondence Address: COHEN SMITH & WHITE, 57 BEDFORD STREET, SUITE 103, LEXINGTON, MA, 02420, US

(21) Appl. No.: 09/681,484

(22) Filed: Apr. 16, 2001

(51) Int. Cl. B32B 1/08

(52) U.S. Cl. 428/36.5; 428/317.1; 428/318.4

(57) ABSTRACT

A system for protecting the body and finish of a vehicle from colliding with the walls and posts of a garage has foam plastic padding attached to the wall and surrounding the posts. The material on the walls is a laminated polyethylene plank, with a backing of contact adhesive, so that it may be easily applied without tools. The padding for the columns is a hollow cylinder formed of the same material as the wall padding, but is formed into hollow cylindrical sheathes, with a slit along the entire major axis of the cylinder so that the sheathes may be forced onto the columns without modification. The cylindrical sheathes have an elastic memory, so that they may be deformed when inserting them onto the posts, but return to their cylindrical shape thereafter.

### BACKGROUND OF INVENTION

1. Field of the Invention

This invention relates to devices to protect the doors and bodies of cars and other vehicles from damage when opening them in a garage, or when entering or leaving a garage. More specifically, this invention relates to the use of padding in the garage to prevent such damage.

2. Description of the Prior Art

A number of automobile protective devices are known in the art. Typical of these are U.S. Pat. Nos. 4,879,543, and 4,81 0,013, both of which deploy padding, or guards, attached to the car door, to protect the door against scuffing or denting.

The damage to the finish of automobiles and other vehicles is annoying to the owners of the vehicles, especially when new. Such minor damage occurs in a number of scenarios. One of the most annoying of these may take place in the owner's garage. Typically, the door may be opened against the wall of the garage, scraping or denting the finish. This is a problem especially in garages with walls of concrete or other hard, unyielding materials.

A second type of problem occurs when the garage has installed columns to support the roof, where the columns are placed in the middle of the garage in a location expected to be between the locations where the vehicles are normally parked. The driver may collide with these columns, often having a steel exterior, which can damage the vehicle's finish, even when the impact is at a very low speed.

Much of the prior art in this field is devoted to protecting car doors against adjacently parked vehicles. The typical approach of the prior art is to place protective devices on the doors, or other parts of the vehicle.

This prior art approach suffers from a number of drawbacks. First, it requires the attachment of the protective device to the vehicle, which is often unsightly, and which often requires the successive attaching and removal of the protective device. Secondly, it only protects those parts of the vehicle which are covered by the protective device.

The current invention improves on the prior art by providing a padding system in the garage of the vehicle owner, which does not require any modification to the vehicle itself. Furthermore, the current invention is inexpensive and easy to install, requiring no tools and no modification to the structure of the garage. Furthermore, the current invention may be easily removed if so desired.

Furthermore, the current invention uses a plastic foam which is extremely robust, resisting tearing, flaking, or sloughing off of the material with repeated use.

### SUMMARY OF INVENTION

It is an objective of the current invention to provide a system for protecting the body and finish of a vehicle from, damage resulting from the collision with the walls, posts, and other supporting structure of a garage.

In accordance with one aspect of the invention, a system for protecting the doors of vehicles in a garage having walls and columns supporting the roof, includes one or more sheathes of cellular plastic material, each encircling a column to a height equal to or greater than the height of the car door.

In accordance with a second aspect of the invention, the sheathes are in the form of hollow cylinders, each with its major axis parallel to the post which it surrounds, and with a slit parallel to the major axis, and extending entirely through the cellular plastic material along the entire major axis.

In accordance with a third aspect of the invention, the sheathes have a memory so that they return to their hollow cylindrical shape after being displaced.

In accordance with a fourth aspect of the invention, the cellular plastic material is polyethylene.

In accordance with a fifth aspect of the invention, the cellular plastic material is made of non-interconnecting cells.

In accordance with a sixth aspect of the invention, the sheathes are formed of laminated material.

In accordance with a seventh aspect of the invention, the laminated material has a film backing approximately 3.5 mils in thickness.

In accordance with an eighth aspect of the invention, the laminated material has a polyethylene foam backing approximately one-eighth inch in thickness.

In accordance with a ninth aspect of the invention, the panels are attached to the garage wall by means of a contact adhesive backing.

In accordance with a final aspect of the invention, the material of the panels is identical to the material of the sheathes.

### BRIEF DESCRIPTION OF DRAWINGS

These, and further features of the invention, may be better understood with reference to the accompanying specification and drawings depicting the preferred embodiment, in which:

FIG. 1 depicts a polyethylene laminate plank with a 3.5 mil film backing.

FIG. 2 depicts a polyethylene laminate plank with a high-density one-eighth-inch polyethylene foam backing.

FIG. 3 depicts a perspective view of a garage with a supporting column enclosed in padding, and a polyethylene plank affixed to the wall.

FIG. 4 depicts a close-up view of the supporting column enclosed in the polyethylene padding.

### DETAILED DESCRIPTION

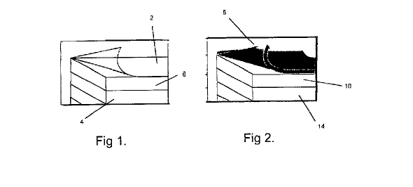

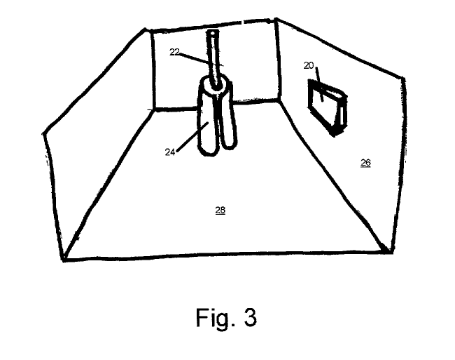

The invention may be understood by referring first to FIG. 1, which depicts a perspective view of the interior of a garage.

The typical home garage is made with interior walls either of concrete or of wood. In either case, the typical garage dimensions are such that, if care is not taken, the vehicle's door may be slammed against the garage wall with force sufficient to damage the door, usually by either denting or scratching.

In the case of many garage designs the roof is supported by posts, usually filled with concrete, but sometimes made only of solid or hollow steel, which is located along a line in the middle of the garage, and parallel to the long dimensions of the vehicles parked within. These columns provide a further danger to the vehicle doors when opened forcefully, and without sufficient care.

In addition to the risk of damaging the doors in the manner described above, there is also the risk that the vehicle itself may collide with the posts of the garage when the vehicle is entering or leaving the garage.

Unlike much of the prior art, the present invention protects the vehicle by padding the walls and posts of the garage, rather than attaching protective devices to the vehicle. The advantage of the current approach is both aesthetic, in that the lines of the vehicle are not altered; and also, practical, since the approach of the present invention protects any part of the vehicle which may collide with the post of the garage, since the post is enclosed over the entire height which may come in contact with the vehicle.

I addition, the present invention allows the user to easily modify the padding to suit the dimensions of his vehicle or vehicles, and also the walls of the garage.

The material of which the padding is made is a plastic foam, which may be easily cut with a knife or scissors, and trimmed to the proper size. This modification is easily performed by the typical owner, so that no additional costs by professional installers is required.

The material of the current invention is critical for proper performance. A polyethylene foam with non-interconnecting cells has been found to provide the proper combination of light weight and resistance to breaking, scuffing, tearing, or abrasion. Other materials used in similar applications, and testing for use in the current application, such as Styrofoam and polyurethane, have proven to lack the strength and resistance to wear required for this application.

Referring now to FIG. 3, the wall of the garage is protected by means of a polyethylene plank 20, attached at approximately the height where the door normally would strike the wall if opened to the door's full extension. The light weight of the polyethylene foam of which the plank is composed is essential, because the plank is attached to the wall by means of a contact adhesive. Other similar systems have required attachment by screws or other types of fasteners, which not only damage the walls, but also provide the threat of additional danger to the doors when striking the fasteners.

Referring to FIG. 1, the plank 20 is further strengthened by forming it of two or more layers 4, 6, bonded together, and forming a laminated structure. An ideal combination for this application is the Stratocell™ Plus material, a laminated foam with a 3.5 mil polyethylene film surface 2 to give additional strength and resistance to scuffing or tearing, which is essential for the current application. This material is manufactured by Sealed Air Corporation, of Saddle Brook, N.J. As an alternative to the above-mentioned material, a ⅛ inch Cellu-Cushion polyethylene layer 8 laminated to a high-density Stratocell layer, produces a 2-inch thick plank, having multiple layers 4, 10, bonded together, which has a superior resistance to scuffing, and is equally appropriate for the application of the current invention.

For this application the plank is supplied to the purchaser with a contact adhesive backing protected by a paper backing, which is removed before attaching the plank to the wall. The wall should first be cleaned with a strong household cleaner, such as detergents containing ammonia, to insure a secure adhesion to the wall.

Still referring to FIG. 3, the column 22 supporting the garage roof is padded by surrounding the column with a polyethylene hollow cylinder 24. This cylinder is either manufactured from a single, solid piece of the same material as the plank, or if may be made from laminated material as well. The polyethylene material of this cylinder is also made from a foam with non-interconnecting cells for superior resistance to scuffing of breaking.

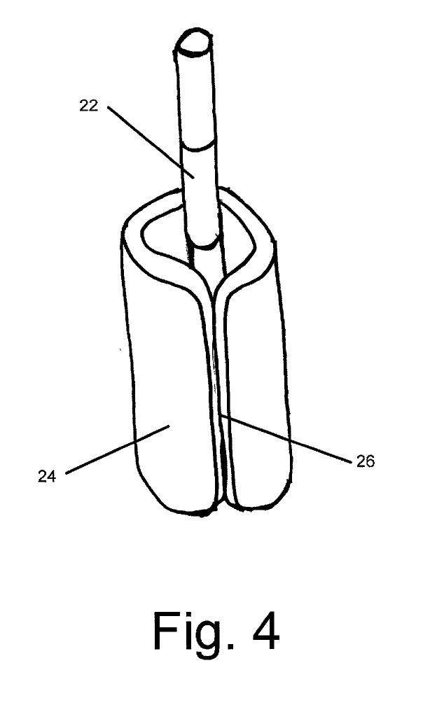

Referring now to FIG. 4, the hollow cylinder 24 is wrapped around the column 22 without the requirement tape, adhesive, or other fastening. The polyethylene foam material is fabricated in the shape of a cylinder, and has an elastic “memory”, so that it will return to its cylindrical shape after being displaced. Thus, to install the padding about the post, it is only necessary to force the cylinder apart at the seam 26, which runs along the length of the cylinder and allows the cylinder to be forced open and the seam of the cylinder pushed against the post, forcing the cylinder about the post, as shown in the figure.

The polyethylene material is easily cut with a knife or scissors. Both the plank and the cylindrical cushion may be trimmed to size before installation. Both are normally provided to the user in sizes somewhat larger that what is typically required, so that the user can trim the padding to the desired size.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

1. A system for protecting the doors of vehicles in a garage having walls and columns supporting the roof, comprising:
one or more sheathes of cellular plastic material, each encircling a column to a height equal to or greater than the height of the car door.

2. The system of claim 1, wherein the sheathes further comprise a hollow cylinder with its major axis parallel to the post which it surrounds, and with a slit parallel to said major axis, and extending entirely through the cellular plastic material along the entire major axis.

3. The system of claim 2, wherein the sheathes have a memory so that they return to their hollow cylindrical shape after being displaced.

4. The system of claim 3, wherein the cellular plastic material further comprises polyethylene.

5. The system of claim 4, wherein the cellular plastic material further comprises non-interconnecting cells.

6. The system of claim 5, wherein the sheathes further comprises laminated material.

7. The system of claim 6, wherein the laminated material further comprises a film backing approximately 3.5 mils in thickness.

8. The system of claim 6, wherein the laminated material further comprises a polyethylene foam backing approximately one-eighth inch in thickness.

9. The system of claim 5, further comprising one or more panels of cellular plastic material attached to the wall.

10. The system of claim 9, wherein the panels are attached to the garage wall by means of a contact adhesive backing attached to said panels.

11. The system of claim 10 wherein the panels and the sheathes are composed of polyethylene foam.

12. The system of claim 11, wherein the polyethylene foam further comprises non-interconnecting cells.

13. The system of claim 12, wherein the polyethylene foam further comprises a high-density foam backing.
